(19) United States
(12) Patent Application Publication
(10) Pub. No.: US 2017/0284441 A1
(43) Pub. Date: Oct. 5, 2017

(54) VEHICLE COMPONENT POSITIONING STRUCTURE

(71) Applicant: EXEDY Corporation, Osaka (JP)

(72) Inventors: Takeshi SENOUE, Osaka (JP); Masahiro NAKATANI, Osaka (JP)

(73) Assignee: EXEDY Corporation

(21) Appl. No.: 15/442,165

(22) Filed: Feb. 24, 2017

(30) Foreign Application Priority Data
Apr. 1, 2016 (JP) 2016-074212

(51) Int. Cl. F16B 19/02; F16F 15/315; F16F 15/14

(52) U.S. Cl. CPC F16B 19/02; F16F 15/14; F16F 15/315; F16F 2230/0005

(57) ABSTRACT

A vehicle component positioning structure positions a second component for a vehicle on a first component for the vehicle. The vehicle component positioning structure includes a first hole portion provided in the first component; and a pin member fitted into the first hole portion and protruding from the first hole portion in order to support the second component. A gap is provided between a portion of an inner peripheral surface of the first hole portion and a portion of an outer peripheral surface of the pin member, the portion of an outer peripheral surface of the pin member opposing the portion of the inner peripheral surface of the first hole portion.

### CROSS-REFERENCE TO RELATED APPLICATIONS

This application claims priority to Japanese Patent Application No. 2016-074212, filed Apr. 1, 2016. The contents of Japanese Patent Application No. 2016-074212 are herein incorporated by reference in its entirety.

### BACKGROUND

### Technical Field

The present disclosure relates to a vehicle component positioning structure, and in particular to a positioning structure for positioning a second component for a vehicle on a first component for a vehicle.

### Background Art

Patent Document 1 (Japan Laid-open Patent Application Publication No. 2013-127279A) discloses a positioning structure for positioning a second component for a vehicle on a first component for a vehicle. A positioning structure for positioning a second component (a torque limiter 3) on a first component (a flywheel 1) is disclosed here. In this positioning structure, a hole portion that has a constant inner diameter is provided in the first component. A pin member (a knock pin 5) is press-fitted into the hole portion by a press-fitting device. The second component is then attached to the protrusion portion of the pin member that protrudes from the hole portion, and the second component is thus positioned on the first component.

In the conventional positioning structure, the portion of the pin member other than the protrusion portion is press-fitted into the hole portion of the first component. In this case, the entirety of the portion of the pin member other than the protrusion portion corresponds to a press-fitting portion of the pin member. In other words, the entirety of the outer peripheral surface of the press-fitting portion of the pin member is a surface that comes into contact with the inner peripheral surface of the hole portion of the first component.

In this positioning structure, the protrusion portion of the pin member is set to protrude by an amount that is effective for supporting the second component. In order to set the protrusion portion to protrude by this amount, the press-fitting device needs to apply a predetermined press-fitting load to the pin member. However, depending on the setting value of the press-fitted amount of the pin member, that is to say the setting value of the amount of protrusion of the pin member, there is a risk that the press-fitting device will not be able to apply a sufficient press-fitting load to the pin member.

For example, the smaller the amount of protrusion of the pin member is, the larger the press-fitted amount of the pin member (the area of the contact surface) is. In other words, the smaller the amount of protrusion of the pin member is, the larger the press-fitting load is. Accordingly, with a press-fitting device that has a small allowable press-fitting load, there is a risk that the press-fitting load necessary for press-fitting the pin member will not be able to be applied to the pin member.

In this way, with the conventional positioning structure, there has been a problem in that when there is no leeway in the allowable press-fitting load of the press-fitting device, it is difficult to set the amount of protrusion of the pin member to the amount of protrusion desired by the designer.

The present disclosure was achieved in light of the above problems, and an object of the present disclosure is to provide a positioning structure that enables the amount of protrusion of the pin member to be set easily.

### BRIEF SUMMARY

(1) A vehicle component positioning structure according to one aspect of the present disclosure is for positioning a second component for a vehicle on a first component for a vehicle. The vehicle component positioning structure includes a first hole portion and a pin member. The first hole portion is provided in the first component. The pin member is fitted into the first hole portion and protrudes from the first hole portion in order to support the second component. A gap is provided between a portion of an inner peripheral surface of the first hole portion and a portion of an outer peripheral surface of the pin member that opposes the portion of the inner peripheral surface of the first hole portion.

In this positioning structure, the gap is provided between the portion of the inner peripheral surface of the first hole portion and the portion of the outer peripheral surface of the pin member that opposes the portion of the inner peripheral surface of the first hole portion, and therefore it is possible to reduce the area of the portion of the pin member that is fitted into the first hole portion (the area of the outer peripheral surface of the pin member that comes into contact with the inner peripheral surface of the first hole portion). Accordingly, with this positioning structure, the amount of protrusion of the pin member can be set to a desired value with a smaller press-fitting load than in conventional art. In other words, with this positioning structure, the amount of protrusion of the pin member can be set easily.

(2) In a vehicle component positioning structure according to another aspect of the present disclosure, it is preferable that the first hole portion has a small-diameter portion and a large-diameter portion having a larger diameter than the small-diameter portion. The large-diameter portion forms the portion of the inner peripheral surface of the first hole portion. The gap is provided between the large-diameter portion and the portion of the outer peripheral surface of the pin member. By configuring the first hole portion and providing the gap as described above, the amount of protrusion of the pin member can be set easily.

(3) In a vehicle component positioning structure according to another aspect of the present disclosure, it is preferable that the pin member has a first shaft portion, a second shaft portion, and a third shaft portion. The first shaft portion is fitted into the small-diameter portion. The second shaft portion is arranged at an inner peripheral portion of the large-diameter portion. The third shaft portion protrudes from the first hole portion. The gap is provided between the large-diameter portion and the second shaft portion. By configuring the pin member and providing the gap as described above, the amount of protrusion of the pin member can be set easily.

(4) In a vehicle component positioning structure according to another aspect of the present disclosure, it is preferable that an inner diameter of the large-diameter portion is substantially the same as an inner diameter of a second hole portion for fixing the second component to the first component. In this case, either one of the large-diameter portion of the first hole portion and the second hole portion can be formed in the same step as the other one of the large-diameter portion of the first hole portion and the second hole portion. In other words, the positioning structure can be formed easily.

(5) In a vehicle component positioning structure according to another aspect of the present disclosure, it is preferable that the second shaft portion of the pin member has a smaller diameter than the first shaft portion. The second shaft portion of the pin member is arranged at the inner peripheral portion of the large-diameter portion. The gap is provided between the large-diameter portion and the second shaft portion. By configuring the pin member and providing the gap as described above, the amount of protrusion of the pin member can be set easily.

(6) In a vehicle component positioning structure according to another aspect of the present disclosure, it is preferable that the gap is provided on an opening side of the first hole portion. In this case, the gap can be formed easily.

(7) In a vehicle component positioning structure according to another aspect of the present disclosure, it is preferable that the pin member has a fourth shaft portion, a fifth shaft portion, and a sixth shaft portion. The fourth shaft portion is fitted into the first hole portion. The fifth shaft portion has a smaller diameter than the fourth shaft portion and is arranged opposing the portion of the inner peripheral surface of the first hole portion. The sixth shaft portion protrudes from the first hole portion. The gap is provided between the portion of the inner peripheral surface of the first hole portion and the fifth shaft portion. By configuring the pin member and providing the gap as described above, the amount of protrusion of the pin member can be set easily.

(8) In a vehicle component positioning structure according to another aspect of the present disclosure, it is preferable that the pin member has a fourth shaft portion, a fifth shaft portion, and a sixth shaft portion. It is preferable that an inner diameter of the portion of the inner peripheral surface of the first hole portion is substantially the same as an inner diameter of a second hole portion for fixing the second component to the first component. In this case, either one of the portion of the inner peripheral surface of the first hole portion and the second hole portion can be formed in the same step as the other one of the portion of the inner peripheral surface of the first hole portion and the second hole portion. In other words, the positioning structure can be formed easily.

(9) In a vehicle component positioning structure according to another aspect of the present disclosure, it is preferable that the pin member has a fourth shaft portion, a fifth shaft portion, and a sixth shaft portion. The gap is provided on an opening side of the first hole portion. In this case, the gap can be formed easily.

With the present disclosure, the amount of protrusion of a pin member can be easily set in a positioning structure.

### BRIEF DESCRIPTION OF DRAWINGS

FIG. 1 is a front view of a flywheel according to an embodiment of the present disclosure;

FIG. 2 is a cross-sectional view of the flywheel taken along a cutting plane line II-II in FIG. 1;

FIG. 3 is an enlarged cross-sectional view of a knock hole of a positioning structure;

FIG. 4 is an enlarged cross-sectional view of the positioning structure;

FIG. 5 is an enlarged cross-sectional view of a positioning structure according to a first variation of the present disclosure; and

FIG. 6 is an enlarged cross-sectional view of a positioning structure according to a second variation of the present disclosure.

### DETAILED DESCRIPTION OF EMBODIMENTS

Configuration of Flywheel Assembly

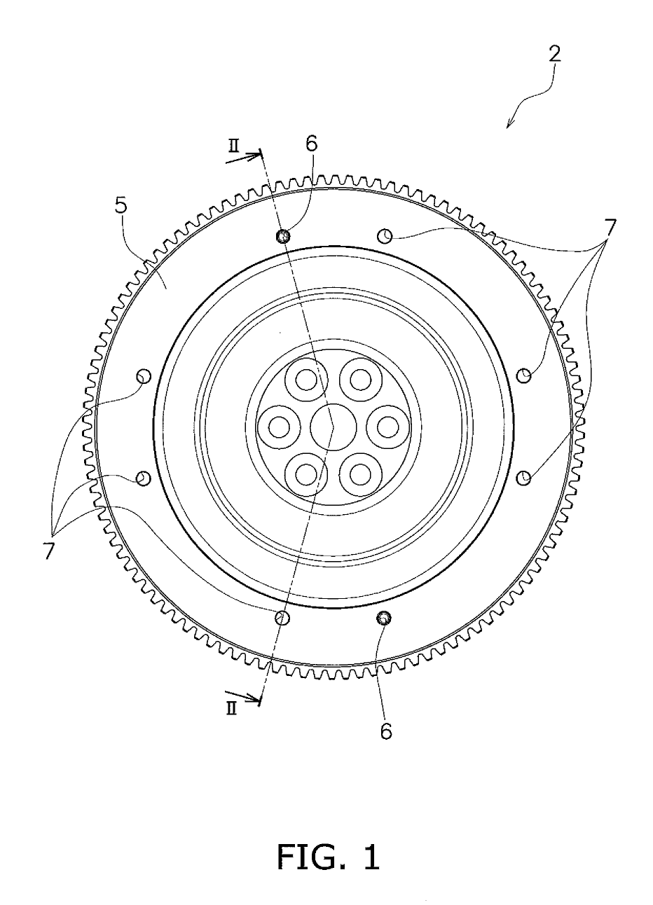

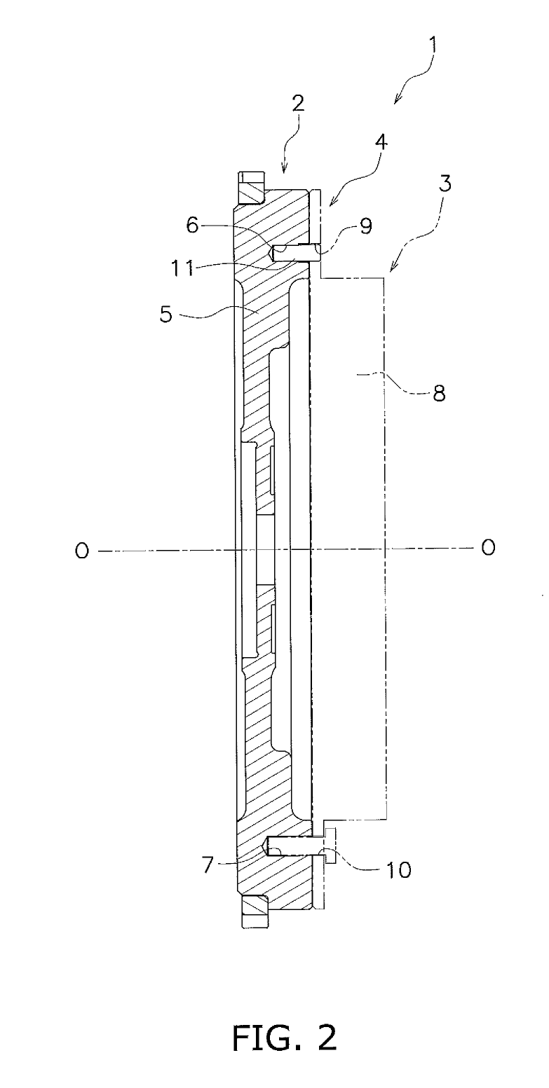

Hereinafter, a positioning structure serving as an embodiment of the present disclosure will be described by way of example of a flywheel assembly 1. FIG. 1 is a front view of a flywheel 2 of the flywheel assembly 1. FIG. 2 is a cross-sectional view of the flywheel 2. The reference sign “O” in FIG. 2 indicates the rotation axis of the flywheel assembly 1. The direction of separation from the rotation axis O will be referred to hereinafter as the diameter direction. Also, the direction of rotation about the rotation axis O will be referred to as the circumferential direction. Furthermore, the direction extending along the rotation axis O will be referred to as the axial direction.

The flywheel assembly 1 has the flywheel 2 (one example of a first component), a damper device 3 (one example of a second component), and a positioning structure 4. The configuration of the flywheel 2 and the configuration of the damper device 3 are substantially the same as conventional configurations, and therefore configurations related to the positioning structure 4 in the flywheel 2 and the damper device 3 will be described in detail below.

Flywheel

Motive power is input to the flywheel 2 from the engine. As shown in FIG. 1, the flywheel 2 has a plate body 5, multiple (e.g., two) knock holes 6 (one example of a first hole portion), and multiple (e.g., six) first fixing holes 7 (one example of a second hole portion). The plate body 5 is substantially disc-shaped. An engine crankshaft (not shown) is attached to the inner peripheral portion of the plate body 5.

As shown in FIG. 1, multiple knock holes 6 are provided in the plate body 5. Specifically, the knock holes 6 are provided in the plate body 5 with gaps therebetween in the circumferential direction. In this example, the knock holes 6 are provided in the plate body 5 with 180-degree gaps therebetween in the circumferential direction. In other words, the knock holes 6 are provided in the plate body 5 at positions opposing each other in the diameter direction. Note that the number of knock holes 6 is not necessarily required to be two, and may be any number greater than or equal to two.

As shown in FIG. 2, the knock holes 6 each extend in the axial direction from one surface of the plate body 5 toward the other surface of the plate body 5. Specifically, the knock holes 6 each extend in the axial direction from the surface on the damper device 3 side toward the surface on the engine side. In this example, the knock holes 6 are each a bottomed hole portion. The openings of the knock holes 6 are provided on the damper device 3 side. The knock holes 6 configure a portion of the positioning structure 4, and later-described knock pins 11 of the positioning structure 4 are attached to the knock holes 6. The detailed configuration of the knock holes 6 will be described in the description of the positioning structure 4.

The first fixing holes 7 are for fixing the damper device 3 to the flywheel 2. As shown in FIG. 1, multiple first fixing holes 7 are provided in the plate body 5. Specifically, the first fixing holes 7 are aligned in the circumferential direction. In this example, three first fixing holes 7 are arranged between two knock holes 6 in the circumferential direction. Note that the number of first fixing holes 7 is not necessarily required to be six, and may be any number greater than or equal to two.

As shown in FIG. 2, the first fixing holes 7 each extend in the axial direction from one surface of the plate body 5 toward the other surface of the plate body 5. Specifically, the first fixing holes 7 each extend in the axial direction from the surface on the damper device 3 side toward the surface on the engine side. In this example, the first fixing holes 7 are each a bottomed hole portion. The openings of the first fixing holes 7 are provided on the damper device 3 side. Female thread portions are formed in the inner peripheral portions of the first fixing holes 7.

Damper Device

The damper device 3 absorbs and attenuates torque fluctuation that is input from the engine to the flywheel 2. As shown by the dashed line in FIG. 2, the damper device 3 has a damper body 8, multiple (e.g., two) support holes 9, and multiple (e.g., six) second fixing holes 10. The configuration of the damper body 8 is substantially the same as a conventional configuration, and therefore will not be described here.

Multiple support holes 9 are provided in the damper body 8. Specifically, the support holes 9 are provided in the damper body 8 with gaps therebetween in the circumferential direction. In this example, the support holes 9 are provided in the damper body 8 with 180-degree gaps therebetween in the circumferential direction. In other words, the support holes 9 are provided in the damper body 8 at positions opposing each other in the diameter direction. Note that the number of support holes 9 is not necessarily required to be two, and may be the same number as or more than the number of knock holes 6.

The support holes 9 each extend in the axial direction from one surface of the damper body 8 toward the other surface of the damper body 8. Specifically, the support holes 9 each extend in the axial direction from the surface on the flywheel 2 side toward the surface opposite to the surface on the flywheel 2 side in the axial direction. In this example, the support holes 9 are each a through-hole. The support holes 9 are arranged at positions opposing the knock holes 6 in the axial direction. The later-described knock pins 11 (third shaft portions 16) of the positioning structure 4 pass through the support holes 9. The detailed configuration of the knock pins 11 will be described in the description of the positioning structure 4.

The second fixing holes 10 are for fixing the damper device 3 to the flywheel 2. Multiple second fixing holes 10 are provided in the damper body 8. Specifically, the second fixing holes 10 are aligned in the circumferential direction. In this example, three second fixing holes 10 are arranged between two support holes 9 in the circumferential direction. Note that the number of second fixing holes 10 is not necessarily required to be six, and may be the same number as or more than the number of first fixing holes 7.

The second fixing holes 10 each extend in the axial direction from one surface of the damper body 8 toward the other surface of the damper body 8. Specifically, the second fixing holes 10 each extend in the axial direction from the surface on the flywheel 2 side toward the surface opposite to the surface on the flywheel 2 side in the axial direction. In this example, the second fixing holes 10 are each a through-hole. Due to the positioning structure 4, the second fixing holes 10 are arranged at positions opposing the first fixing holes 7 in the axial direction.

In this state, the shaft portions of fixing bolts are inserted into the second fixing holes 10 from the surface opposite to the surface on the flywheel 2 side, toward the surface on the flywheel 2 side. Male thread portions formed on the shaft portions of the fixing bolts are then screwed to the female thread portions of the first fixing holes 7. Accordingly, the damper device 3 is fixed to the flywheel 2.

Positioning Structure

The positioning structure 4 is for positioning the damper device 3 on the flywheel 2. As shown in FIGS. 1 to 4, the positioning structure 4 includes multiple (e.g., two) knock holes 6 (one example of a first hole portion), and multiple (e.g., two) knock pins 11 (one example of a pin member).

In this example, the direction in which a pin axial center C1 (see FIG. 4) of a knock pin 11 extends will be referred to as the pin axial direction. Also, the direction of separation from the pin axial center C1 will be referred to hereinafter as the pin diameter direction. Also, the direction of rotation about the pin axial center C1 will be referred to as the pin circumferential direction.

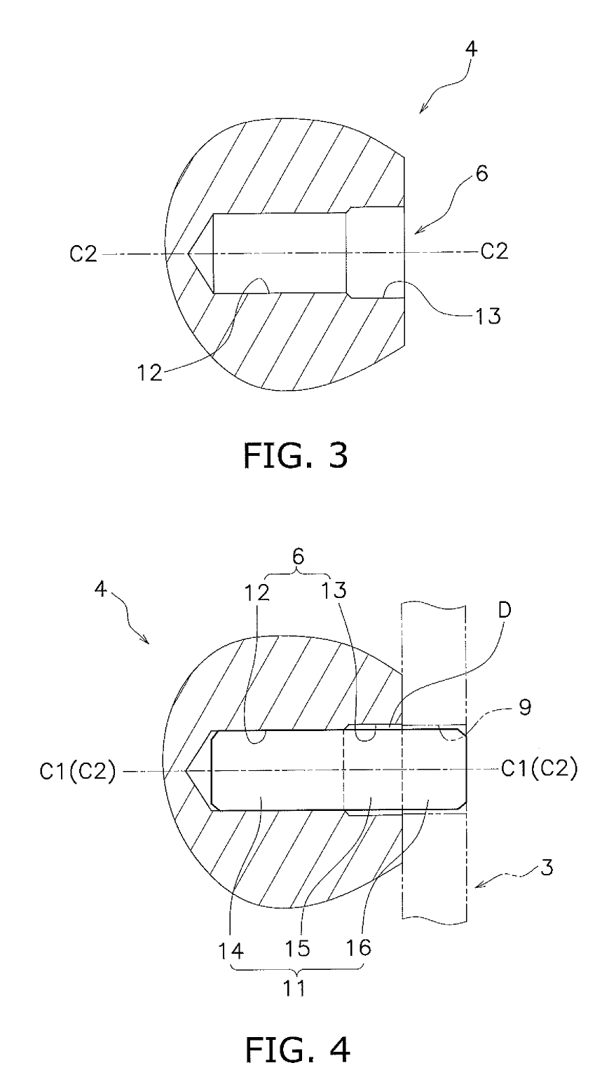

Also, the direction in which a first hole axial center C2 (see FIG. 3) of a knock hole 6 extends will be referred to as the hole axial direction. Also, the direction of separation from the first hole axial center C2 will be referred to hereinafter as the hole diameter direction. Furthermore, the direction of rotation about the first hole axial center C2 will be referred to as the hole circumferential direction.

Furthermore, as shown in FIG. 4, in the state where the knock pin 11 is mounted in the knock hole 6, the pin axial center C1 and the first hole axial center C2 are coaxial, and the pin axial direction, the pin diameter direction, and the pin circumferential direction substantially match the hole axial direction, the hole diameter direction, and the hole circumferential direction respectively.

Note that the positioning structure 4 includes multiple knock holes 6 and multiple knock pins 11 in this example, and the positioning structure 4 may include multiple (e.g., two) support holes 9 described above.

Knock Hole

As described with reference to FIGS. 1 and 2, the knock holes 6 are provided in the flywheel 2. As shown in FIGS. 2 and 4, a portion of the inner peripheral surface of each knock hole 6 opposes a portion of the outer peripheral surface of a corresponding knock pin 11 in the diameter direction. In other words, a portion of the inner peripheral surface of the knock hole 6 is a non-contact portion that does not come into contact with the knock pin 11. The other portion of the inner peripheral surface of the knock hole 6 excluding the portion is in contact with the knock pin 11. The other portion of the inner peripheral surface of the knock hole 6 excluding the portion is a contact portion that comes into contact with the knock pin 11.

Specifically, as shown in FIG. 3, the knock hole 6 is a bottomed hole portion. The bottom portion of a small-diameter portion is cone-shaped. The knock hole 6 has a small-diameter portion 12 and a large-diameter portion 13. The small-diameter portion 12 forms the aforementioned contact portion (the other portion of the inner peripheral surface of the knock hole 6 excluding the portion). The small-diameter portion 12 is provided on the bottom portion side of the knock hole 6. The knock pin 11 is fitted into the small-diameter portion 12. Specifically, a later-described first shaft portion 14 of the knock pin 11 is fitted into the small-diameter portion 12.

The large-diameter portion 13 forms the aforementioned non-contact portion (the portion of the inner peripheral surface of the knock hole 6). The large-diameter portion 13 is provided on the opening side of the knock hole 6. The large-diameter portion 13 has a larger diameter than the small-diameter portion 12. Specifically, the inner diameter of the large-diameter portion 13 is larger than the inner diameter of the small-diameter portion 12 with respect to the first hole axial center C2.

Also, the inner diameter of each large-diameter portion 13 is substantially the same as the inner diameter of the first fixing holes 7 (see FIG. 2) of the flywheel 2. Specifically, the inner diameter of the large-diameter portion 13 with respect to the first hole axial center C2 is substantially the same as the inner diameter of the first fixing hole 7 with respect to a second hole axial center C3.

Furthermore, a gap D is provided between the large-diameter portion 13 and a portion of the outer peripheral surface of the knock pin 11. Specifically, the gap D is provided in the diameter direction between the large-diameter portion 13 and a later-described second shaft portion 15 of the knock pin 11 (a portion of the outer peripheral surface of the knock pin 11).

Knock Pin

As shown in FIGS. 2 and 4, the knock pins 11 are each a pin member. The knock pin 11 is column-shaped and elongated in substantially one direction. The knock pin 11 is fitted into a knock hole 6 and protrudes from the knock hole 6 in order to support the damper device 3. A portion of the outer peripheral surface of the knock pin 11 opposes the large-diameter portion 13 of the knock hole 6 in the diameter direction. In other words, a portion of the outer peripheral surface of the knock pin 11 is a non-contact portion that does not come into contact with the knock hole 6.

Specifically, the knock pin 11 has a first shaft portion 14, a second shaft portion 15, and a third shaft portion 16. The first shaft portion 14 is the portion that is fitted into the knock hole 6. The first shaft portion 14 is formed on one end side of the knock pin 11. The first shaft portion 14 is fitted into the small-diameter portion 12 of the knock hole 6. Specifically, the outer diameter of the first shaft portion 14 is slightly larger than the inner diameter of the small-diameter portion 12 of the knock hole 6, and the first shaft portion 14 is press-fitted into the small-diameter portion 12 of the knock hole 6. The knock pin 11 is thus attached to the flywheel 2.

The second shaft portion 15 is the portion that opposes the large-diameter portion 13 of the knock hole 6. The second shaft portion 15 forms the aforementioned non-contact portion (the portion of the outer peripheral surface of the knock pin 11). The second shaft portion 15 is formed between the first shaft portion 14 and the third shaft portion 16, and is integrated with the first shaft portion 14 and the third shaft portion 16. The outer diameter of the second shaft portion 15 is substantially the same as the outer diameter of the first shaft portion 14. The second shaft portion 15 is arranged at the inner peripheral portion of the large-diameter portion 13 of the knock hole 6. In this state, the outer peripheral surface of the second shaft portion 15 opposes the inner peripheral surface of the large-diameter portion 13 of the knock hole 6 in the diameter direction. In other words, the gap D is provided in the diameter direction between the second shaft portion 15 and the large-diameter portion 13 of the knock hole 6.

The third shaft portion 16 is the portion that protrudes from the knock hole 6. The third shaft portion 16 is formed on the other end side of the knock pin 11. The third shaft portion 16 is integrated with the second shaft portion 15. The outer diameter of the third shaft portion 16 is substantially the same as the outer diameter of the second shaft portion 15. The third shaft portion 16 is arranged outside of the knock hole 6. For example, the third shaft portion 16 protrudes outward from the knock hole 6 relative to the surface of the flywheel 2 on the damper device 3 side. The length of the third shaft portion 16 in the pin axial direction corresponds to the protruding length of the knock pin 11.

In the state where the first shaft portions of the above-described knock pins 11 are fitted into the knock holes 6 of the flywheel 2, the third shaft portions 16 pass through the support holes 9 of the damper device 3. The damper device 3 is thus positioned on the flywheel 2 via the knock pins 11.

Features

In the positioning structure 4 described above, the gap D is provided between the portion of the inner peripheral surface of the knock hole 6 and the portion of the outer peripheral surface of the knock pin 11 that opposes the portion of the inner peripheral surface of the knock hole 6. The gap D is provided between the large-diameter portion 13 of the knock hole 6 and the second shaft portion 15 of the knock pin 11 (the portion of the outer peripheral surface of the knock pin 11) on the opening side of the knock hole 6.

For this reason, it is possible to reduce the area of the portion of the knock pin 11 that is fitted into the knock hole 6 (the area of the outer peripheral surface of the knock pin 11 that comes into contact with the inner peripheral surface of the knock hole 6). Accordingly, with the positioning structure 4, the amount of protrusion of the knock pin 11 (the length of the third shaft portion 16 in the pin axial direction) can be set to a desired value with a smaller press-fitting load than in conventional art. In other words, with this positioning structure 4, the amount of protrusion of the knock pins 11 can be set easily.

Also, with the positioning structure 4, the press-fitting load applied when fitting (press-fitting) the knock pins 11 into the knock holes 6 can be set to an appropriate press-fitting load by adjusting the axial length of the large-diameter portions 13 of the knock holes 6.

Furthermore, with the positioning structure 4, the inner diameter of the large-diameter portions 13 of the knock holes 6 is substantially the same as the inner diameter of the first fixing holes 7 of the flywheel 2. Accordingly, the large-diameter portions 13 of the knock holes 6 and the first fixing holes 7 can be formed in the same step. In other words, the positioning structure 4 can be formed easily.

First Variation

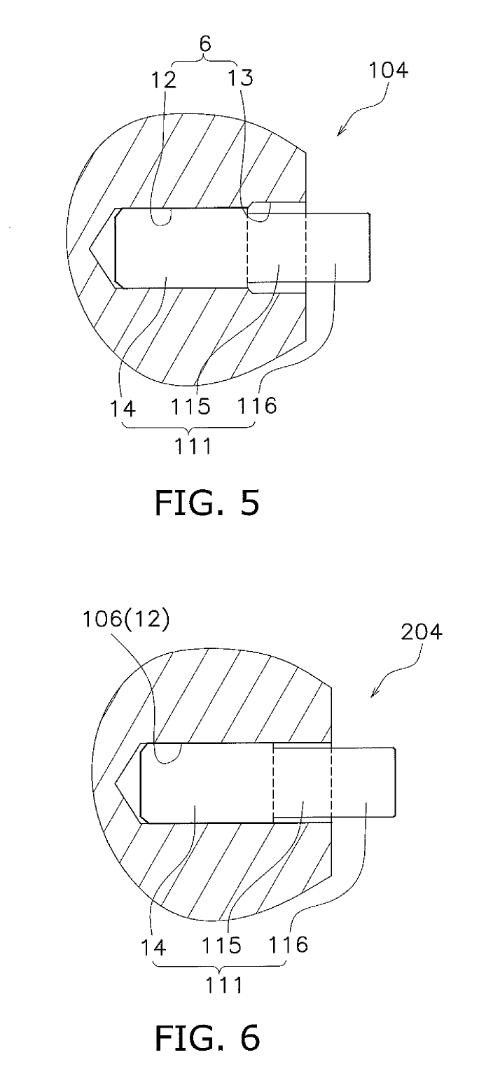

The above-described positioning structure 4 may be configured as described below. Note that configurations of a positioning structure 104 described below that are the same as in the above embodiment are denoted by the same reference signs in FIG. 5 and will not be described.

Specifically, in the positioning structure 104 shown in FIG. 5, the outer diameter of a second shaft portion 115 and the outer diameter of a third shaft portion 116 of a knock pin 111 are smaller than the outer diameter of the first shaft portion 14. The second shaft portion 115 of the knock pin 111 is arranged at the inner peripheral portion of the large-diameter portion 13 of the knock hole 6. The third shaft portion 116 protrudes from the knock hole 6. The gap D is provided in the diameter direction between the second shaft portion 115 of the knock pin 111 and the large-diameter portion 13 of the knock hole 6. Even when configuring the knock pin 111 and providing the gap D as described above, effects similar to the above-described effects can be obtained.

Second Variation

The above-described positioning structure 104 may be configured as described below. Note that configurations of a positioning structure 204 described below that are the same as in the above embodiment are denoted by the same reference signs in FIG. 6 and will not be described.

Specifically, in the positioning structure 204 shown in FIG. 6, similarly to the first variation, the knock pin 111 has the first shaft portion 14 (one example of a fourth shaft portion), the second shaft portion 115 (one example of a fifth shaft portion), and the third shaft portion 116 (one example of a sixth shaft portion).

In the configuration of the positioning structure 204, the configuration of a knock hole 106 is different from the configuration in the first variation. In this case, the inner diameter of the inner peripheral surface of the knock hole 106 is substantially the same along the hole axial direction. In other words, in the second variation, the knock hole 106 is not provided with the large-diameter portion 13.

Also, the inner diameter of portion of the inner peripheral surface of the knock hole 106 is substantially the same as the inner diameter of the first fixing hole 7 of the flywheel 2. In this example, this portion of the inner peripheral surface of the knock hole 106 is the portion that opposes the second shaft portion 115 of the knock pin 111 in the diameter direction.

Furthermore, the outer diameter of the second shaft portion 115 and the outer diameter of the third shaft portion 116 of the knock pin 111 are smaller than the outer diameter of the first shaft portion 14. The second shaft portion 115 of the knock pin 111 is arranged at the inner peripheral portion of the knock hole 106. The gap D is provided in the diameter direction between the second shaft portion 15 of the knock pin 111 and the knock hole 106.

Even when configuring the knock pin 111 and providing the gap D as described above, effects similar to the above-described effects can be obtained.

### Other Embodiments

The present disclosure is not limited to the embodiments described above, and various modifications and alterations can be made without departing from the scope of the present disclosure.

(A) Although the positioning structures 4, 104, and 204 for positioning the damper device 3 on the flywheel 2 are described in the above embodiments, the flywheel 2 may be positioned on the damper device 3.

(B) Although the positioning structures 4, 104, and 204 for positioning the damper device 3 on the flywheel 2 are described in the above embodiments, the positioning structures 4, 104, and 204 may position another member as long as they are for positioning two members for a vehicle relative to each other. For example, the positioning structures 4, 104, and 204 may be used for positioning the transmission relative to the engine.

(C) Although the case where the cross-section of the knock pins 11 and 111 is circular is described as an example in the above embodiments, the cross-section of the knock pins 11 and 111 may be polygonal. In this case, the outer diameter of the knock pins 11 and 111 is defined by the diameter of a circle transcribed around the corners of the knock pins 11 and 111 with respect to the pin axial center C1.

(D) Although the case where the knock holes 6 and 106 are bottomed hole portions is described as an example in the above embodiments, the knock holes 6 and 106 may be through-holes.

(E) Although the case where the inner diameter of the large-diameter portion 13 of the knock holes 6 and 106 is constant is described as an example in the above embodiments, the large-diameter portion 13 may be tapered as long as it has a larger diameter than the small-diameter portion 12.

1. A vehicle component positioning structure for positioning a second component for a vehicle on a first component for the vehicle, the vehicle component positioning structure comprising:
a first hole portion provided in the first component; and
a pin member fitted into the first hole portion and protruding from the first hole portion in order to support the second component, wherein
a gap is provided between a portion of an inner peripheral surface of the first hole portion and a portion of an outer peripheral surface of the pin member, the portion of an outer peripheral surface of the pin member opposing the portion of the inner peripheral surface of the first hole portion.

2. The vehicle component positioning structure according to claim 1, wherein
the first hole portion includes a small-diameter portion and a large-diameter portion, the large-diameter portion including a larger diameter than the small-diameter portion,
the large-diameter portion forms the portion of the inner peripheral surface of the first hole portion, and
the gap is provided between the large-diameter portion and the portion of the outer peripheral surface of the pin member.

3. The vehicle component positioning structure according to claim 2, wherein
the pin member has a first shaft portion, a second shaft portion, and a third shaft portion, the first shaft portion fitted into the small-diameter portion, the second shaft portion arranged at an inner peripheral portion of the large-diameter portion, the third shaft portion protruding from the first hole portion, and
the gap is provided between the large-diameter portion and the second shaft portion.

4. The vehicle component positioning structure according to claim 2, wherein
an inner diameter of the large-diameter portion is substantially the same as an inner diameter of a second hole portion for fixing the second component to the first component.

5. The vehicle component positioning structure according to claim 3, wherein
the second shaft portion includes a smaller diameter than the first shaft portion, and is arranged at the inner peripheral portion of the large-diameter portion.

6. The vehicle component positioning structure according to claim 1, wherein
the gap is provided on an opening side of the first hole portion.

7. The vehicle component positioning structure according to claim 1, wherein
the pin member includes a fourth shaft portion, a fifth shaft portion, and a sixth shaft portion, the fourth shaft portion fitted into the first hole portion, the fifth shaft portion including a smaller diameter than the fourth shaft portion and arranged opposing the portion of the inner peripheral surface of the first hole portion, the sixth shaft portion protruding from the first hole portion, and
the gap is provided between the portion of the inner peripheral surface of the first hole portion and the fifth shaft portion.

8. The vehicle component positioning structure according to claim 7, wherein
an inner diameter of the portion of the inner peripheral surface of the first hole portion is substantially the same as an inner diameter of a second hole portion for fixing the second component to the first component.

9. The vehicle component positioning structure according to claim 7, wherein
the gap is provided on an opening side of the first hole portion.
